(19) United States
(12) Patent Application Publication
(10) Pub. No.: US 2002/0075108 A1
(43) Pub. Date: Jun. 20, 2002

(54) Method of remotely actuating a membrane switch by attractive or repulsive magnetic force

(76) Inventors: Lester G. Ward, Greensboro, NC (US); Howard Weinstein, Greensboro, NC (US)

Correspondence Address: COATS & BENNETT, P.L.L.C., POST OFFICE BOX 5, RALEIGH, NC, 27602, US

(21) Appl. No.: 09/738,683

(22) Filed: Dec. 15, 2000

(51) Int. Cl. H01H 9/00

(52) U.S. Cl. 335/205

(57) ABSTRACT

A membrane switch that uses a magnetic force for assisting in the actuation process. A magnet positioned adjacent to the membrane switch causes a magnetic attraction or repulsion that remotely transfers a limited but sufficient force for closing the membrane switch. The invention includes a magnet, a membrane switch, and an actuator. In an attraction actuation embodiment, the actuator is constructed of a magnetically-affected material that is attracted to the magnet to thereby close the membrane switch. In a repulsion actuation embodiment, the actuator is constructed of a magnetic material with the poles of the magnet and actuator inversely aligned such that they repel each other. In both embodiments, the actuating force applied to the magnet or actuator is not directly passed to the membrane switch.

### FIELD OF THE INVENTION

The present invention is directed to a method of actuating a membrane switch and, more particularly, to a method of positioning a membrane switch relative to a magnetic material and magnet to use the magnetic force therebetween to actuate the switch.

### BACKGROUND OF THE INVENTION

Membrane switches are used in a variety of applications, including but not limited to selection of the grade of fuel and/or interaction with payment devices in a fuel dispensing environment. Membrane switches typically have a flexible plastic membrane layer separated from a substrate by a nonconductive spacer. Openings in the spacer permit a user to push the membrane through the spacer, bringing facing electrical contacts on the internal surfaces of the membrane and substrate into contact with one another thereby closing the switch. The natural resilience of the membrane returns it to its spaced position upon removal of the actuating force.

Membrane switches are relatively easily damaged by rough treatment. Additionally, outdoor environments may causes the switches to degrade and become ineffective. The electrical contacts are often very fragile and continual actuation and deactuation often result in damage and failure of the switch. Additionally, the actuating force causing contact of the membrane layers is directly applied to the layers thereby increasing the likelihood of damage to the switch.

A similar concern is that the membrane switch continually work in a reliable manner. A switch, such as that previously described on a fuel dispenser, may be actuated hundreds of times each day. The switch should be able to undergo this amount of usage and still operate properly. If the switch becomes worn or if an adequate actuating force is not applied to the membrane layers, a user may have to repeatedly actuate the switch to close the contacts and begin service. This is frustrating to the user, and may result in loss of sales if the worn switch is not repaired. Additionally, service calls may have to be performed to fix a broken membrane switch, which may be costly. Thus, the switch should be easy for a user to actuate, yet somehow restrict the amount of force directly applied to the layers so as not to cause premature wear.

### SUMMARY OF THE INVENTION

The invention is directed to a membrane switch that uses a magnetic force for assisting in the actuation process. A magnet positioned adjacent to the membrane switch causes a magnetic attraction or repulsion that remotely transfers a limited but sufficient force for closing the membrane switch. The invention includes a magnet, a membrane switch, and an actuator constructed of a magnetically-affected material.

In an attraction actuation embodiment, the membrane switch is positioned between the magnet and a magnetically-attracted actuator. The magnet is pressed within proximity of the actuator. The magnetic force of the magnet pulls the actuator against the membrane switch thereby activating the membrane switch.

The repulsion actuation embodiment includes a magnetic actuator positioned between the membrane switch and the magnet. The magnet and actuator are aligned such that their poles are inversely positioned (south to south or north to north). As the magnet is moved within close proximity to the actuator, magnetic force pushes the actuator away from the magnet and against the membrane switch.

In both embodiments, the physical actuating force applied by the user is not directly transferred to the membrane switch as the magnet and switch do not touch. Rather, a magnetic attraction or repulsion remotely transfers a limited but sufficient pressure to close the membrane switch. This type of switch actuation is reliable, and does not cause undue wear on the membrane switch.

### BRIEF DESCRIPTION OF THE DRAWINGS

FIG. 1 is a perspective view of one embodiment of at least one membrane switch of the present invention within a fuel dispenser;

FIG. 2 is an exploded partial perspective view illustrating one embodiment of an attraction actuation embodiment of the present invention;

FIG. 3 illustrates a partial perspective view of the switch of FIG. 2 in an actuated state;

FIG. 4 is a partial perspective view of another embodiment of the attraction actuation embodiment;

FIG. 5 is an exploded partial perspective view of one embodiment of a repulsion actuation embodiment of the present invention;

FIG. 6 is a partial perspective view illustrating the switch of FIG. 5 in an actuated state; and

FIG. 7 is an exploded partial perspective view of another embodiment of the repulsion actuation embodiment.

### DETAILED DESCRIPTION OF THE INVENTION

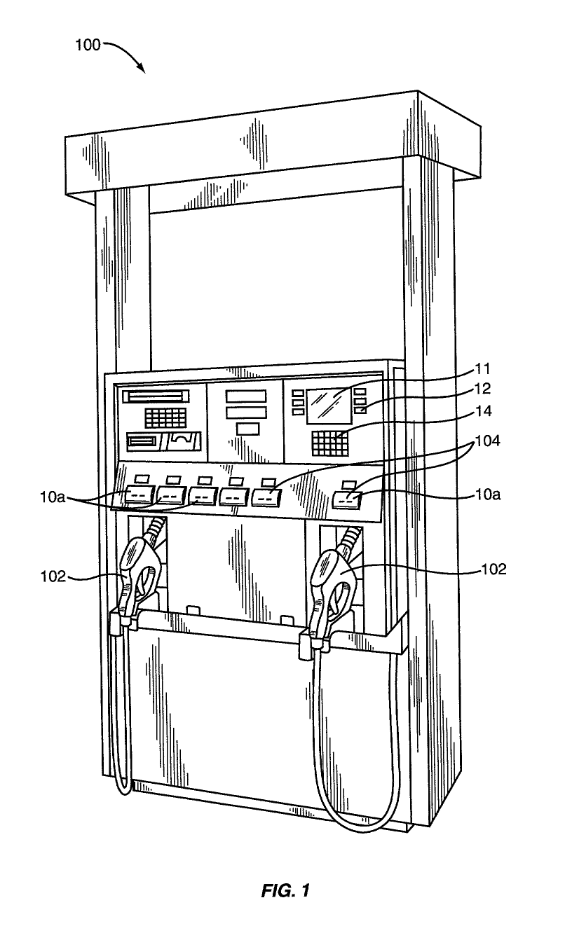

FIG. 1 illustrates a fuel dispenser 100 representative of one use of the membrane switch 10 of the present invention. A number of membrane switches 10 may be positioned across the face of the dispenser 100 for the user to select the grade of fuel dispensed through nozzles and hose assembly 102. A user presses the surface 104 of the membrane switch 10 to select the grade of fuel. Fuel dispenser 100 comprises an outer housing having an associated display 11, soft keys 12, and a keypad 14 to interact with the user for selecting fuel and possibly other goods and services. One embodiment of a fuel dispenser is disclosed in U.S. Pat. No. 6,098,879, herein incorporated by reference in its entirety. FIG. 1 is included for illustrative purposes of one environment in which membrane switch 10 is used. Numerous other environments are also contemplated by the present invention such as cameras, computer keypads, soft keys, appliances such as washing machines, calculators, and scientific and medical equipment.

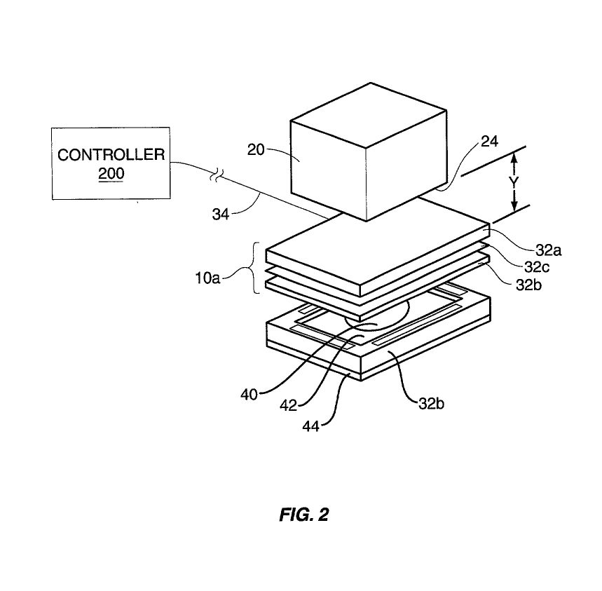

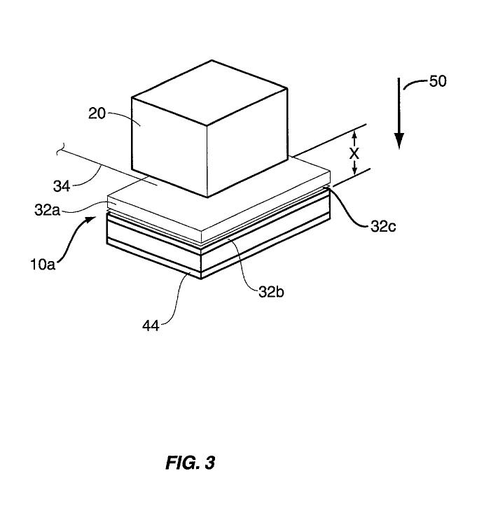

FIG. 2 illustrates one embodiment of a membrane switch 10a using an attraction actuation method. Membrane switch 10a includes layers 32a, 32b, and 32c positioned between magnet 20 and a magnetically-attracted actuator 40. Magnet 20 is moveably positioned relative to the membrane switch 10a and moves between a non-actuated position illustrated in FIG. 2 and an actuated position illustrated in FIG. 3. Magnet first end 24 is positioned a distance Y from membrane switch first layer 32a in the deactivated state illustrated in FIG. 2 and a distance X in the activated state illustrated in FIG. 3. Magnet 20 maintains a distance from and never contacts membrane switch 10a thereby ensuring that no undue force is exerted on the membrane switch 10a which could cause damage and/or premature wear.

Membrane switch 10a comprises a first layer 32a and a second layer 32b. A spacer layer 32c may also be positioned within the switch 10a. The opposing sides of each layer (illustrated as the bottom side of first layer 32a and the top side of second layer 32b in FIG. 2) include electrical contacts. The switch 10a is open when the layers 32a, 32b are separated and closed when the layers 32a, 32b contact. In one embodiment, the membrane layers 32a, 32b are composed of a flexible plastic or polyester sheet with conductive ink containing silver or carbon is screened thereon. Other examples of a membrane switch include U.S. Pat. No. 5,921,382 entitled “Magnetically Enhanced Membrane Switch”, and U.S. Pat. No. 6,069,552 entitled “Directionally Sensitive Switch”, both of which are incorporated here in their entirety.

One of the membrane layers 32a, 32b is further equipped with a contact line 34 that extends to a controller unit 200 for powering the equipment actuated by the switch 10a. In the fuel dispenser embodiment of FIG. 1, controller 200 controls the function of the fuel dispenser 100 including accepting payment, activating a fuel pump, activating a vapor recovery pump, etc. Alternatively, contact line 34 may extend directly to the unit being actuated and bypass a controller arrangement.

An actuator 40 is positioned adjacent the second layer 32b and on the opposite side of the switch 10a from the magnet 20. In the attraction actuation method, actuator 40 is constructed of a magnetically-attracted material that is magnetically drawn to the magnet 20 when placed within a predetermined range. The predetermined range is sized such that actuator 40 is weakly attracted when magnet 20 is placed a distance Y from the first layer 32a, and is strongly attracted when magnet 20 is placed a distance X from the first layer 32a. In one embodiment, actuator 40 is constructed of iron or steel. The magnetic range may vary depending upon the power of the magnet 20, and size and composition of the actuator 40. Actuator 40 may have a variety of shapes, dimensions, and sizes.

Membrane switch second layer 32b may include a cavity 42 for housing the actuator 40. Additionally, a backing plate 44 may be positioned along the second layer 32b for containing the actuator 40. Actuator 40 is attached to second layer 32b such that the magnet attraction results in the second layer 32b moving with the actuator 40. Actuator 40 may be fixed in place via adhesive, mechanical fasteners, or positioned within cavity 42 and entombed by a backing plate 44 and a face plate (not illustrated). One skilled in the art will understand that a variety of options are available for attaching actuator 40 to second layer 32b and are included within the scope of the present invention.

In the non-actuated state illustrated in FIG. 2, magnet 40 is positioned a distance Y from the first layer 32a such that little magnetic attraction occurs with the actuator 40. In this state, the first and second layers 32a, 32b are separated and the switch 10a is not actuated. In the actuated state illustrated in FIG. 3, magnet 20 is moved in the direction of arrow 50 towards the membrane switch 10a via an actuating force. In the embodiment illustrated in FIG. 1, the actuating force is supplied by the user pressing the surface 104 of the membrane switch 10a. In FIG. 3, the proximity of the magnet 20 to the actuator 40 results in a magnetic force of adequate strength to pull the actuator 40 towards the magnet 20. This results in the first and second layers 32a, 32b contacting and the membrane switch 10a being actuated. It is important to note that the magnet 20 maintains a minimum distance between the magnet first end 24 and first membrane layer 32a. This orientation causes the force applied to the membrane switch 10a to be limited to that supplied by the magnetic attraction thus preventing undue force that may be applied by the user to be conveyed to the membrane switch 10a. Additionally, the strength of the magnet and the distance X is predetermined such that the switch consistently closes when the magnet 20 is moved to the closed state of FIG. 3.

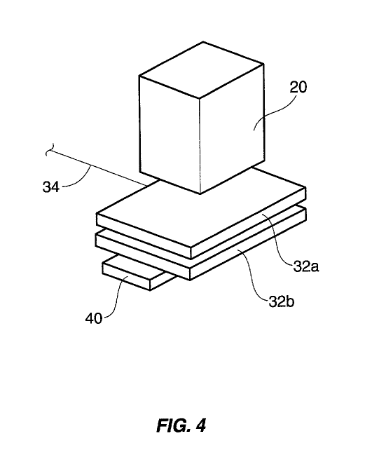

FIG. 4 illustrates another embodiment of the attraction actuation method. Membrane switch first and second layers 32a, 32b are positioned between magnet 20 and actuator 40. In the non-actuated state, magnet 20 is positioned a distance from actuator 40 and first and second layers 32a, 32b are separated. In the actuated state in which magnet 20 is moved closer, actuator 40 is attracted and moves towards magnet 20 thereby forcing the layers 32a, 32b together and closing the membrane switch.

This embodiment may also feature the actuating force of the user being applied to the actuator 40 which moves the actuator 40 within range of magnet 20. Once within magnetic range, the closing force is caused by the magnetic attraction between magnet 20 and actuator 40.

In one embodiment, the roles of the actuator 40 and magnet 20 may be reversed. The actuator 40 is maintained a minimum distance from the membrane switch 10a while the magnet 20 contacts the switch 10a causing the layers 32a and 32b to be forced together thus causing switch 10a closure.

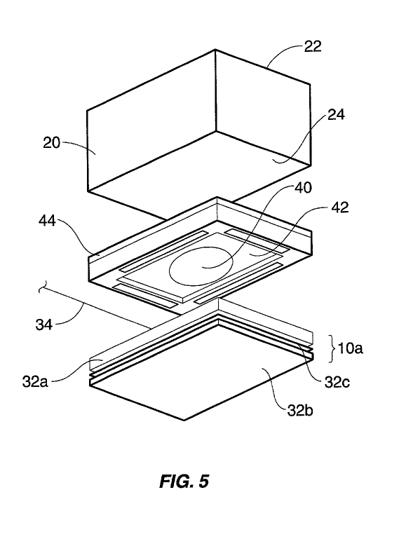

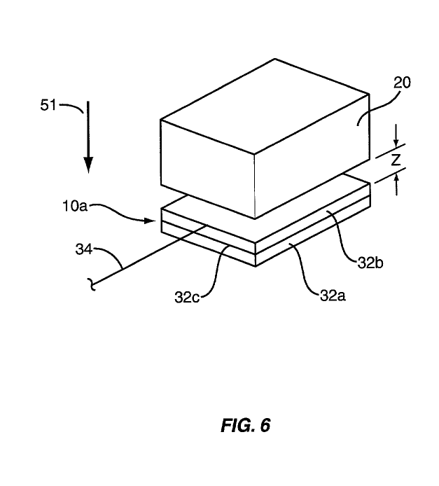

FIGS. 5 and 6 illustrate one embodiment of repulsion actuation. The actuator 40 is a magnetic material positioned within a cavity 42. A backing member 44 may again be positioned for containing the actuator 40 in the cavity 42. Additionally, a face plate (not illustrated) may be positioned between the actuator 40 and membrane switch 10a to enclose the actuator 40 within the cavity 42. As with the previous method, actuator 40 may be held within the cavity 42 in a manner of different formats. The membrane switch first layer 32a is positioned distant from the magnet 20 with the second layer 32b and actuator 40 positioned therebetween. Additionally, a spacer 32c may be positioned between the membrane layers 32a, 32b.

The magnet 20 and magnetic actuator 40 are arranged such that their poles are inversely positioned. This orientation may include magnet south end facing actuator south end, or magnet north end facing actuator north end such that when brought in range, a magnetic repulsion occurs.

In the non-activated state illustrated in FIG. 5, magnet 20 and actuator 40 are positioned a distance apart such that magnetic force is not strong enough to move the actuator 40. When an actuating force is applied to the magnet 20 as illustrated by arrow 51 in FIG. 6, the inversely positioned poles of magnet 20 and actuator 40 repel one another resulting in the actuator 40 pushing layer 32a to contact layer 32b causing the electrical contacts (not illustrated) on layers 32a and 32b to contact. The repulsion and contacting of the first and second layers 32a, 32b result in the membrane switch 10a being actuated. As with the previous embodiment, the repulsion actuation embodiment again maintains a distance Z between the magnet 20 and membrane switch 10a.

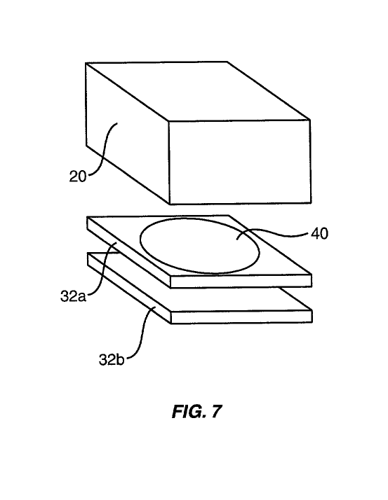

FIG. 7 illustrates another embodiment of the repulsion actuation method. Actuator 40 is positioned between magnet 20 and first and second layers 32a, 32b. In the non-actuated state, the distance between the magnet 20 and actuator 40 is sized such that a slight repulsion force is created. When magnet 20 and actuator 40 are moved closer together, repulsion forces cause actuator to move away from magnet 20 thereby forcing first and second layers 32a, 32b together and closing the switch.

The above described and illustrated embodiments comprise the magnet 20 positioned distant from the membrane switch 10a. In alternative embodiments that correspond to those described above, the actuator 40 may be positioned distant from the membrane switch 10a. By way of example using the embodiment illustrated in FIG. 2, the roles of the actuator and magnet may be reversed. The magnet may be placed within the membrane switch and the actuator distantly positioned. The reversal of roles between the actuator and magnet may be included in each of the embodiments illustrated and described.

The present invention may also include a means for causing the magnet 20 to move away from the actuator 40 to reopen the membrane switch 10a. In one embodiment, a spring is positioned to bias the magnet 20 away and separate the membrane switch layers 32a, 32b.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of activating a membrane switch, comprising the steps of:
a) spacing a magnet and an actuator a distance apart;
b) positioning a membrane switch in proximity to the magnet and actuator; and
c) reducing the distance between the magnet and actuator and causing a magnetic force to actuate the membrane switch.

2. The method of claim 1, wherein the membrane switch includes first and second layers, the step of positioning the membrane switch in proximity to the magnet and actuator comprises positioning at least one of the layers between the magnet and the actuator and the magnetic force results in the first and second layers to be pressed together.

3. The method of claim 2, further including positioning the actuator within one of the first and second layers.

4. The method of claim 2, further including positioning the magnet within one of the first and second layers.

5. The method of claim 1, wherein like poles of the magnet and actuator are inversely aligned and the step of positioning the membrane switch in proximity to the magnet and actuator comprises adjacently positioning the actuator and magnet and reducing the distance between the magnet and actuator causes a repulsion force such that the membrane switch is actuated.

6. The method of claim 5, wherein the membrane switch comprises first and second layers and the actuator is positioned within one of the layers.

7. The method of claim 5, wherein the membrane switch comprises first and second layers and the magnet is positioned within one of the layers.

8. The method of claim 1, wherein the step of reducing the distance between the magnet and actuator comprises moving the magnet within a magnetic range of the actuator.

9. The method of claim 1, wherein the step of reducing the distance between the magnet and actuator comprises moving the actuator within a magnetic range of the magnet.

10. The method of claim 1, wherein the step of causing the magnetic force to actuate the membrane switch results in movement of both the magnet and actuator.

11. A method of activating a membrane switch comprising the steps of:
a) positioning at least a first layer of a membrane switch between a magnet and a magnetically-affected actuator;
b) moving at least one of the magnet and actuator to reduce a distance therebetween;
c) magnetically drawing the magnet and actuator towards one another thereby forcing the first layer and a membrane switch second layer together; and
d) maintaining a distance between the magnet and actuator.

12. The method of claim 11, wherein the actuator is attached to the second layer and magnetically drawing the magnet and actuator towards one another causes the first and second layers to contact.

13. The method of claim 11, wherein the magnet is attached to the second layer and magnetically drawing the magnet and actuator towards one another causes the first and second layers to contact.

14. The method of claim 11, wherein the step of moving at least one of the magnet and actuator to reduce a distance therebetween includes moving the magnet within a magnetic range of the actuator.

15. The method of claim 11, wherein the step of moving at least one of the magnet and actuator to reduce a distance therebetween includes moving the actuator within a magnetic range of the magnet.

16. The method of claim 11, wherein the force of contacting the first and second layers together is equal to the magnetic force between the actuator and magnet.

17. The method of claim 1 1, wherein the first and second layers are positioned between the magnet and actuator.

18. A method of activating a switch comprising the steps of:
a) placing a magnetic actuator between a magnet and at least one layer of a membrane switch;
b) inversely aligning the opposite poles of the actuator and the magnet;
c) reducing the distance between the magnet and actuator thereby magnetically repelling the actuator and the magnet; and
d) causing the at least one layer of the membrane switch and a second layer to come in contact.

19. The method of claim 18, wherein the actuator is attached to the one layer positioned between the magnetic actuator and the magnet, the step of causing the one layer and second layer to come in contact comprises moving the one layer against a second layer that is positioned away from the magnet.

20. The method of claim 18, wherein the magnet is attached to the one layer positioned between the magnetic actuator and the magnet, the step of causing the one layer and second layer to come in contact comprises moving the one layer against a second layer that is positioned away from the actuator.

21. A fuel dispenser comprising:
a) an outer housing;
b) an input device associated with said outer housing to receive a fuel purchase request;
c) at least one nozzle and hose assembly to distribute fuel; and
d) at least one membrane switch associated with said outer housing, each of said at least one membrane switch having an outer surface contacted by a user to move a magnet and actuator within a magnetic range thereby actuating said membrane switch.

22. The fuel dispenser of claim 21, wherein said at least one membrane switch comprises first and second layers with at least one of said layers being positioned between said magnet and said actuator.

23. The fuel dispenser of claim 21, wherein said at least one membrane switch comprises first and second layers and said magnet and said actuator being adjacently positioned.

24. The fuel dispenser of claim 21, wherein said input device is selected from the group consisting essentially of soft keys, and a keypad.
